(19) United States
(12) Patent Application Publication
(10) Pub. No.: US 2015/0096227 A1
(43) Pub. Date: Apr. 9, 2015

(54) WIRE POT HANGER

(71) Applicants: Joshua D. Deason, Manteca, CA (US); Antonio E. Soares, Manteca, CA (US)

(72) Inventors: Joshua D. Deason, Manteca, CA (US); Antonio E. Soares, Manteca, CA (US)

(21) Appl. No.: 14/458,105

(22) Filed: Aug. 12, 2014

Related U.S. Application Data
(60) Provisional application No. 61/886,487, filed on Oct. 3, 2013.

(51) Int. Cl. A47G 7/04; A01G 9/02; A47F 5/01

(52) U.S. Cl. CPC A47G 7/047; A47F 5/01; A01G 9/02
USPC 47/67; 248/27.8; 211/85.23

(57) ABSTRACT

Wire pot hangers are presented including: a wire form including a number of bends, a planar base portion sized and formed to support a pot, a lateral portion extending inwardly from the planar base portion to a centered balance point of the planar base portion, a vertical portion extending upwardly from the lateral portion, the vertical portion configured for extending through a central hole of the pot, and a hook portion formed along an upper end of the vertical portion, the hook portion sized to pass through the central hole of the pot. In some embodiments, the hook portion includes: a hook extending through an arc having a radius; a hook extension extending from the hook toward the planar base portion, where the hook extension is offset from the vertical portion by the radius, and a hook connector extending from the hook extension toward the vertical portion.

### FIELD OF INVENTION

Embodiments of the present invention relate to wire pot hangers for use in hanging single and multiple pots.

### BACKGROUND

Pot hangers are generally well-known and widely used. Conventional pot hangers typically wrap around a pot and provide multiple lines that attach to a single point. While those conventional pot hangers are useful, when the plant overgrows the pot, it may be difficult or impossible to remove the plant from the pot hanger without damaging the plant. In some solutions, pot hangers are fabricated from a single wire that traverses around the outside of the pot. Unfortunately, an additional means of securing the pot to the hanger must be utilized in those examples to avoid pot slippage. As such wire pot hangers are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Wire pot hangers are presented including: a wire form including a number of bends, a planar base portion sized and formed to support a pot, a lateral portion extending inwardly from the planar base portion to a centered balance point of the planar base portion, a vertical portion extending upwardly from the lateral portion, the vertical portion configured for extending through a central hole of the pot, and a hook portion formed along an upper end of the vertical portion, the hook portion sized to pass through the central hole of the pot. In some embodiments, the hook portion includes: a hook extending through an arc having a radius; a hook extension extending from the hook toward the planar base portion, where the hook extension is off-set from the vertical portion by the radius, and a hook connector extending from the hook extension toward the vertical portion. In some embodiments, the arc defines a semi-circle. In some embodiments, the hook extension has a length of at least twice the radius. In some embodiments, the arc is in a range of approximately 170 to 190°. In some embodiments, the single piece of bent material further includes, a partial loop formed along the lateral portion and positioned proximal with the vertical portion, the partial loop sized to receive a second wire form. In some embodiments, the planar base portion is formed into a shape selected from the group consisting of: a semi-circular shape, a geometric shape, a letter shape, a freeform shape, and an animal shape. In some embodiments, wire pot hangers further include a base plate having a plate central hole, the base plate dimensioned larger than the planar base portion and selected to further support the pot.

In other embodiments hanging pot assemblies are presented including: a pot having, a base with a central hole; and a wire pot hanger including, a wire form including a number of bends, the wire form including, a planar base portion sized and formed to support a pot, a lateral portion extending inwardly from the planar base portion to a centered balance point of the planar base portion, a vertical portion extending upwardly from the lateral portion, the vertical portion configured for extending through the central hole, and a hook portion formed along an upper end of the vertical portion, the hook portion sized to pass through the central hole. In some embodiments, the hook portion includes: a hook extending through an arc having a radius; a hook extension extending from the hook toward the lateral portion, where the hook extension is off-set from the vertical portion by the radius, and a hook connector extending from the hook extension toward the vertical portion. In some embodiments, the single piece of bent material further includes, a partial loop formed along the lateral portion and positioned toward the vertical portion, the partial loop sized to receive a second wire form.

In other embodiments, multi-tiered vertical pot hanger assemblies for hanging a number of pots in a vertically tiered arrangement are presented including: a first wire pot hanger and a second pot hanger for hanging from the first pot hanger; the first wire pot hanger including, a wire form including a number of bends, the wire form including, a first planar base portion sized to support a first pot, a first lateral portion extending inwardly from the first planar base portion to a first centered balance point of the first planar base, a first vertical portion extending upwardly from the first lateral portion, the first vertical portion configured for extending through a first central hole of the first pot, a first hook portion formed along an upper end of the vertical portion, the hook portion sized to pass through the first central hole of the first pot, and a first partial loop formed along the first lateral portion and proximal with the first vertical portion; and the wire second pot hanger mechanically coupled with the first pot hanger along the first partial loop, the second wire pot hanger including, a second wire form including a number of bends, the second wire form including, a second planar base portion sized to support a second pot, a second lateral portion extending inwardly from the second planar base portion to a second centered balance point of the second planar base, a second vertical portion extending upwardly from the second lateral portion, the second vertical portion configured for extending through a second central hole of the second pot, a second hook portion formed along a second upper end of the second vertical portion, the second open wire loop sized to pass through the second central hole of the second pot. In some embodiments, the first and second hook portions each include: a hook extending through an arc having a radius; a hook extension extending from the hook toward the lateral portion, where the hook extension is offset from the vertical portion by the radius, and a hook connector extending from the hook extension toward the vertical portion.

### BRIEF DESCRIPTION OF THE DRAWINGS

Te present invention is illustrated by way of example, and not by way of limitation, in the figures of the accompanying drawings and in which like reference numerals refer to similar elements and in which:

FIG. 1 is an illustrative representation of a wire pot hanger in accordance with embodiments of the present invention;

FIG. 2 is an illustrative representation of a wire pot hanger in accordance with embodiments of the present invention;

FIG. 3 is an illustrative representation of wire pot hanger having a base plate in accordance with embodiments of the present invention;

FIG. 4 is an illustrative representation of hangers for a wire pot hanger in accordance with embodiments of the present invention;

FIG. 5 is an illustrative representation of a multi-tiered vertical pot hanger assembly in accordance with embodiments of the present invention;

FIG. 6 is an illustrative representation of planar base portion shapes in accordance with embodiments of the present invention; and

FIG. 7 is an illustrative representation of alternative pot hangers in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

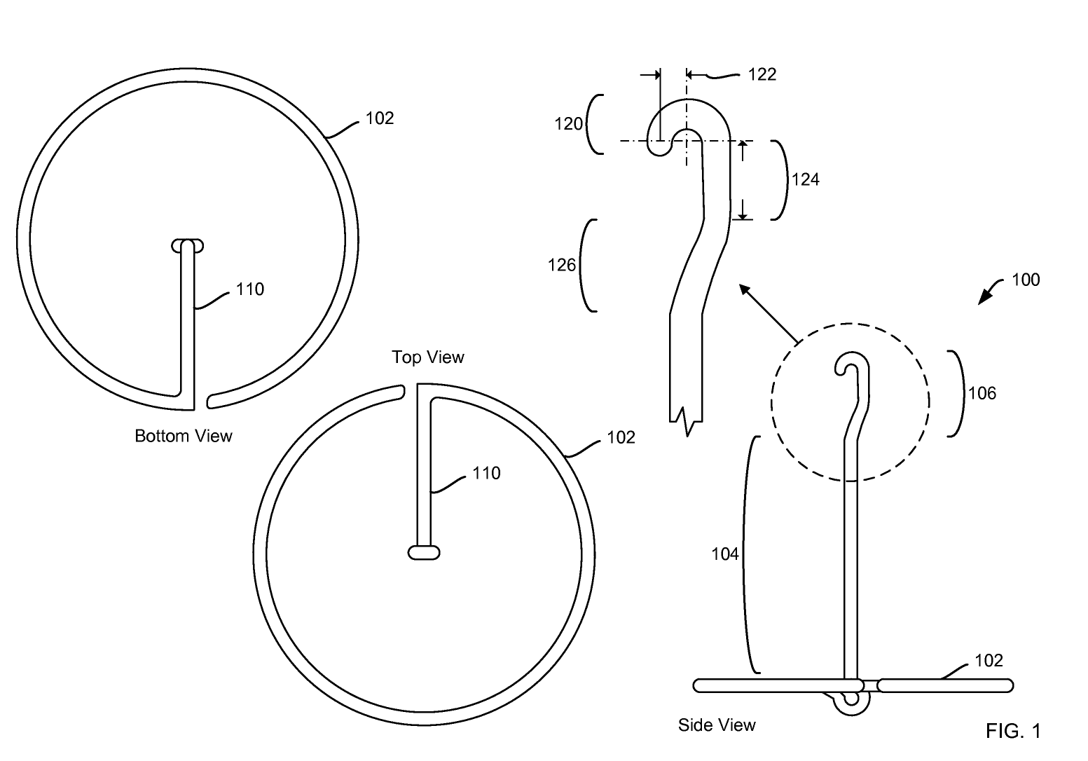

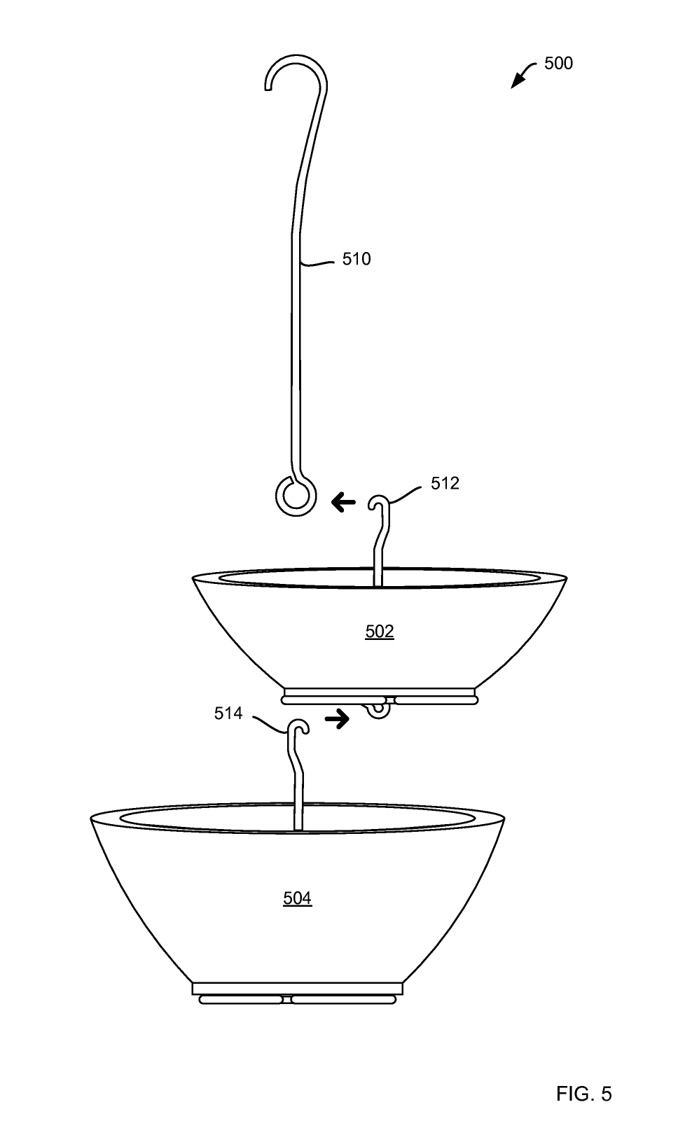

FIG. 1 is an illustrative representation of a wire pot hanger 100 in accordance with embodiments of the present invention. In particular, various views of embodiments are provided for clarity. As noted above, In particular, wire pot hanger 100 is illustrated. Further as illustrated, wire pot hanger 100 may be formed from a wire form having multiple bends formed into planar base portion 102 that may be sized and formed to support a pot such as pot 502 (FIG. 5). Still further, wire pot hanger 100 may include lateral portion 110 that extends inwardly from planar base portion 102 to a centered balance point of planar base portion 102. In addition, wire pot hanger 100 may include vertical portion 104 configured for extending upwardly from lateral portion 110. As may be appreciated, vertical portion 104 may be configured for extending through a central hole of pot 502 (FIG. 5). Still further, wire pot hanger 100 may include open (or closed—not shown) hook portion 106 formed along upper end of vertical portion 104. It may be further appreciated that, in embodiments, hook portion 106 may be sized to pass through a central hole of pot 502 (FIG. 5). Further illustrated is partial loop 108 formed along lateral portion 110 and proximal with vertical portion 104, As may be seen, partial loop 108 may be sized to receive a second wire form.

Further illustrated is hook portion 106 in further detail. As illustrated, hook portion includes hook 120 extending through an arc having radius (R) 122. In embodiments, the arc is in a range of approximately 170 to 190°. In some embodiments, the arc defines a semi-circle. It may be desirable to have an arc having a limited range in order to facilitate insertion into a pot center hole. For example, if a hook having an arc that extends through 250° is utilized, then the hook requires a radius smaller than that of the pot center hole in order to be inserted into the pot center hole. In addition, it may be desirable to have a an arc having a limited range so that the hook may be passed through another eyelet or loop without requiring excessive tipping. In the above example, a hook having an arc that extends through 250° would require the hanger to be excessively tipped to insert into an eyelet or loop, which may be unduly hazardous to the user. Further illustrated is hook extension 124 that extends from hook 120 toward the planar base portion, wherein the hook extension is off-set from the vertical portion by radius 122. In some embodiments, the length of the hook extension is at least equal to twice the radius as illustrated by the following formula:

L=2R, where L is the length of the hook extension and R is the radius of the hook.

In some embodiments, radius R is in a range of approximately 0.25 to 2.00 inches. The extension length and offset allows the hook to be inserted into a hole having a radius considerably smaller than the radius of the hook. As such, a variety of pots may be accommodated by embodiments presented herein. Further illustrated is hook connector 126 that extends from hook extension 128 toward vertical portion 104.

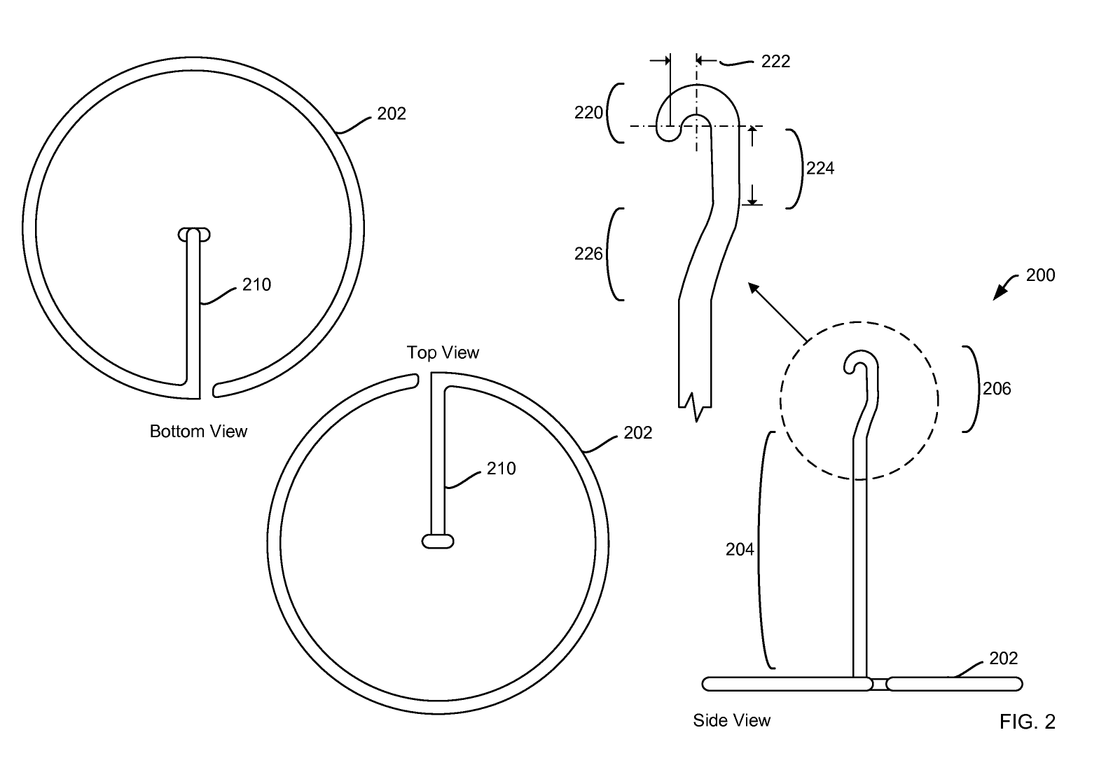

FIG. 2 is an illustrative representation of a wire pot hanger 200 in accordance with embodiments of the present invention. In particular, various views of embodiments are provided for clarity. As noted above, In particular, wire pot hanger 200 is illustrated. Further as illustrated, wire pot hanger 200 may be formed from a wire form having multiple bends formed into planar base portion 202 that may be sized and formed to support a pot such as pot 504 (FIG. 5). Still further, wire pot hanger 200 may include lateral portion 210 that extends inwardly from planar base portion 202 to a centered balance point of planar base portion 202. In addition, wire pot hanger 200 may include vertical portion 204 configured for extending upwardly from lateral portion 210. As may be appreciated, vertical portion 204 may be configured for extending through a central hole of pot 504 (FIG. 5). Still further, wire pot hanger 200 may include open or closed—not shown) hook portion 206 formed along upper end of vertical portion 204. It may be further appreciated that, in embodiments, hook portion 206 may be sized to pass through a central hole of pot 504 (FIG. 5).

Further illustrated is hook portion 206 in further detail. As illustrated, hook portion includes hook 220 extending through an arc having radius (R) 222. In embodiments, the arc is in a range of approximately 170 to 190°. In some embodiments, the arc defines a semi-circle. It may be desirable to have an arc having a limited range in order to facilitate insertion into a pot center hole. For example, if a hook having an arc that extends through 250° is utilized, then the hook requires a radius smaller than that of the pot center hole in order to be inserted into the pot center hole. In addition, it may be desirable to have a an arc having a limited range so that the hook may be passed through another eyelet or loop without requiring excessive tipping. In the above example, a hook having an arc that extends through 250° would require the hanger to be excessively tipped to insert into an eyelet or loop, which may be unduly hazardous to the user. Further illustrated is hook extension 224 that extends from hook 220 toward the planar base portion, wherein the hook extension is off-set from the vertical portion by radius 222. In some embodiments, the length of the hook extension is at least equal to twice the radius as illustrated by the following formula:

L=2R, where L is the length of the hook extension and R is the radius of the hook.

In some embodiments, radius R is in a range of approximately 0.25 to 2.00 inches. The extension length and offset allows the hook to be inserted into a hole having a radius considerably smaller than the radius of the hook. As such, a variety of pots may be accommodated by embodiments presented herein. Further illustrated is hook connector 226 that extends from hook extension 228 toward vertical portion 204.

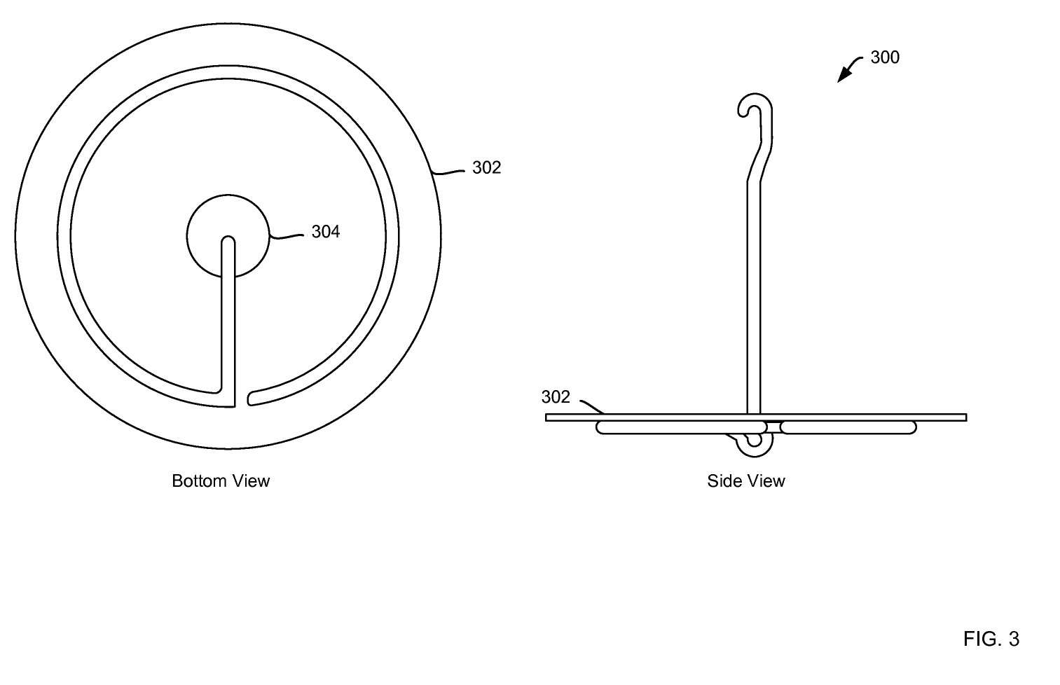

FIG. 3 is an illustrative representation of wire pot hanger 300 having a base plate in accordance with embodiments of the present invention. In some embodiments, it may be desirable to support a larger pot. In those embodiments, it may be useful to provide base plate 302 having plate central hole 304. In embodiments, the base plate may be dimensioned larger than the planar base portion and selected to further support a pot.

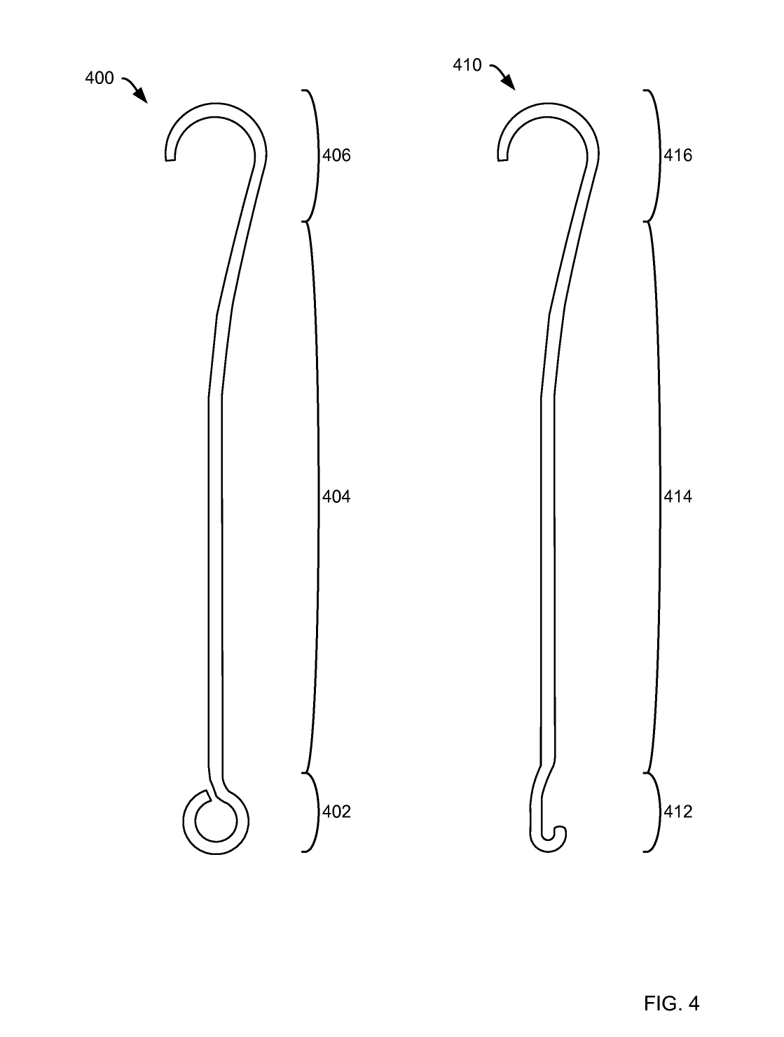

FIG. 4 is an illustrative representation of hangers 400 and 410 for a wire pot hanger in accordance with embodiments of the present invention. Hangers may be configured in any number of manners without departing from embodiments provided herein. For example, hangers may be formed from a single wire form or multiple wire forms. As illustrated, hanger 400 may include hanger connector 402 for connecting with wire plant hanger embodiments. In particular hanger connector 402 is an eyelet. Further illustrated is hanger extension portion 404 that extends from hanger connector 402. Hanger extension portion embodiments may be of any length without limitation. Further illustrated is hanger hook portion 406 that extends from hanger extension portion 404. Ranger hook portion embodiments may be utilized for attaching to a suitable substrate.

Further illustrated, hanger 410 may include hanger connector 412 for connecting with wire plant hanger embodiments. In particular hanger connector 412 is a hook. Further illustrated is hanger extension portion 414 that extends from hanger connector 412. Hanger extension portion embodiments may be of any length without limitation. Further illustrated is hanger hook portion 416 that extends from hanger extension portion 414. Hanger hook portion embodiments may be utilized for attaching to a suitable substrate.

FIG. 5 is an illustrative representation of a multi-tiered vertical pot hanger assembly in accordance with embodiments of the present invention. In particular, first wire pot hanger 512 is illustrated for use with pot 502. First wire pot hanger embodiments are discussed in further detail above for FIG. 1. Further illustrated is second wire pot hanger 514 for use with pot 504. Second wire pot hanger embodiments are discussed in further detail above for FIG. 2. Still further illustrated is hanger 510. Hanger embodiments are discussed in further detail above for FIG. 4. As illustrated, two wire pot hangers are utilized. However any number of wire pot hangers may be utilized in embodiments without limitation. In addition, any type of pot having a center hole may be utilized without limitation in embodiments provided herein.

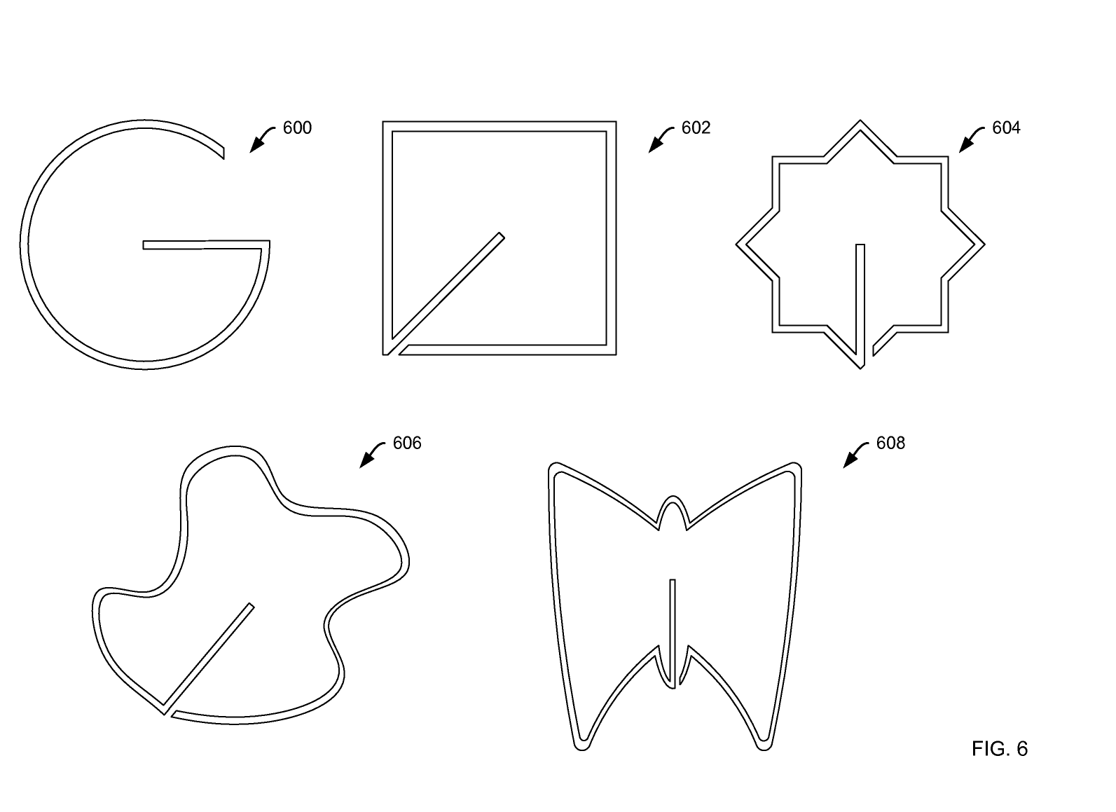

FIG. 6 is an illustrative representation of planar base portion shapes embodiments in accordance with embodiments of the present invention. In particular, planar base portions may be shaped in any manner without departing from embodiments provided herein. For example, letter shape 600, geometric shape 602, star shape 604, abstract shape 606, and animal shape 608 may be utilized without departing from embodiments. It may be appreciated that different shapes may provide an aesthetic value to embodiments provided herein.

Methods of Use

As may be appreciated, embodiments provided herein may be utilized in a variety of manners For example, a method for utilizing a hanging pot assembly includes: providing a pot having a base with a central hole and a wire pot hanger. In these methods, the wire pot hanger may include: a wire form comprising a number of bends, the wire form including, a planar base portion sized and formed to support a pot, a lateral portion extending inwardly from the planar base portion to a centered balance point of the planar base portion, a vertical portion extending upwardly from the lateral portion, the vertical portion configured for extending through the central hole, and a hook portion formed along an upper end of the vertical portion, the hook portion sized to pass through the central hole. In some method embodiments the hook portion includes: a hook extending through an arc having a radius; a hook extension extending from the hook toward the lateral portion, wherein the hook extension is off-set from the vertical portion by the radius, and a hook connector extending from the hook extension toward the vertical portion.

In other methods, multiple wire forms may be utilized to make a multi-tiered vertical pot hanger assembly.

Methods of Manufacture

Embodiments provided herein may be manufactured from a single wire manually or automatically. In addition, wire form manufacture may include a surface treatment such as, for example, paint, plating, powder coating, or anodizing. In some embodiments, wear surfaces such as an inside bend of a hook or loop may be double or treble treated.

Kits

As may be appreciated, embodiments may be provided in kit form in any of a number of configurations. For example:

Kit 1: Single wire form;

Kit 2: Single wire form and Hanger;

Kit 3: Single wire form, Hanger, and pot;

Kit 1: Two wire forms;

Kit 2: Two wire forms and Hanger; and

Kit 3: Two wire forms, Hanger, and pots.

It may be appreciated that these kit embodiments are provided for illustrative purposes and should not be construed as limiting as any number of configurations may be utilized without limitation.

### Alternative Embodiments

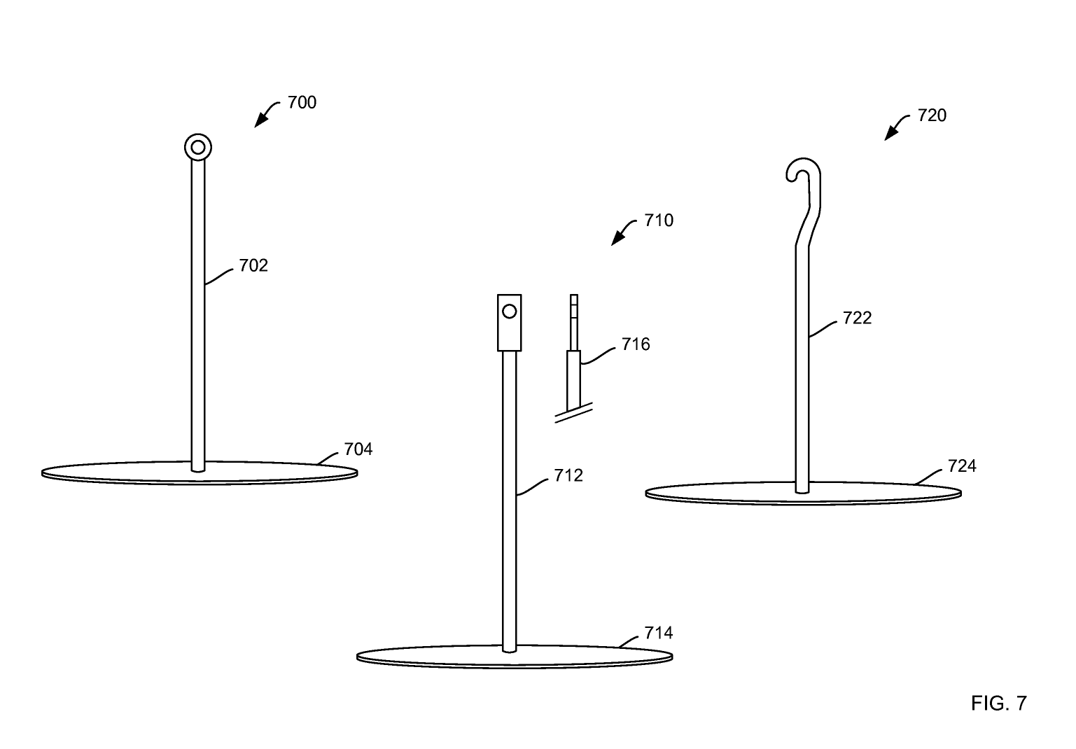

FIG. 7 is an illustrative representation of alternative pot hangers in accordance with embodiments of the present invention. For example, pot hanger 700 may include an eyelet attached with vertical portion 702, which, in turn, may be attached with base plate 704. It may be appreciated that in previous embodiments disclosed above, a unitary wire form may be utilized. However, the base portion may include a base plate as illustrated. In addition, vertical portion 702 may be a wire form or a tube. Indeed any suitable material may be utilized without departing from embodiments provided herein. For example, a polymeric compound, a metal compound, or an epoxy compound may be utilized in embodiments without limitation.

Further illustrated, pot hanger 710 may include a flattened eyelet attached with vertical portion 712, which, in turn, may be attached with base plate 714. For clarity, profile view 716 is illustrated. It may be appreciated that in previous embodiments disclosed above, a unitary wire form may be utilized. However, the base portion may include a base plate as illustrated. In addition, vertical portion 712 may be a wire form or a tube. Indeed any suitable material may be utilized without departing from embodiments provided herein. For example, a polymeric compound, a metal compound, or an epoxy compound may be utilized in embodiments without limitation.

Still further illustrated, pot hanger 720 may include a hook portion, such as those disclosed above, attached with vertical portion 722, which, in turn, may be attached with base plate 724. It may be appreciated that in previous embodiments disclosed above, a unitary wire form may be utilized. However, the base portion may include a base plate as illustrated. In addition, vertical portion 722 may be a wire form or a tube. Indeed any suitable material may be utilized without departing from embodiments provided herein. For example, a polymeric compound, a metal compound, or an epoxy compound may be utilized in embodiments without limitation.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A wire pot hanger comprising:
a wire form comprising a plurality of bends,
a planar base portion sized and formed to support a pot,
a lateral portion extending inwardly from the planar base portion to a centered balance point of the planar base portion,
a vertical portion extending upwardly from the lateral portion, the vertical portion configured for extending through a central hole of the pot, and
a hook portion formed along an upper end of the vertical portion, the hook portion sized to pass through the central hole of the pot.

2. The wire pot hanger of claim wherein the hook portion comprises:
a hook extending through an arc having a radius;
a hook extension extending from the hook toward the planar base portion, wherein the hook extension is off-set from the vertical portion by the radius, and
a hook connector extending from the hook extension toward the vertical portion.

3. The wire pot hanger of claim 2, wherein the arc defines a semi-circle.

4. The wire pot hanger of claim 2, wherein the hook extension has a length of at least twice the radius.

5. The wire pot hanger of claim 3, wherein the arc is in a range of approximately 170 to 190°.

6. The wire pot hanger of claim 1, wherein the single piece of bent material further includes,
a partial loop formed along the lateral portion and positioned proximal with the vertical portion, the partial loop sized to receive a second wire form.

7. The wire pot hanger of claim 1, wherein the planar base portion is formed into a shape selected from the group consisting of: a semi-circular shape, a geometric shape, a letter shape, a freeform shape, and an animal shape.

8. The wire pot hanger of claim 1, further comprising a base plate having a plate central hole, the base plate dimensioned larger than the planar base portion and selected to further support the pot.

9. A hanging pot assembly comprising:
pot having a base with a central hole; and
a wire pot hanger including,
a wire form comprising a plurality of bends, the wire form including,
a planar base portion sized and formed to support a pot,
a lateral portion extending inwardly from the planar base port to a centered balance point of the planar base portion,
a vertical portion extending upwardly from the lateral portion, the vertical portion configured for extending through the central hole, and
a hook portion formed along an upper end of the vertical portion, the hook portion sized to pass through the central hole.

10. The assembly of claim 9, wherein the hook portion comprises:
a hook extending through an arc having a radius;
a hook extension extending from the hook toward the lateral portion, wherein the hook extension is off-set from the vertical portion by the radius, and
a hook connector extending from the hook extension toward the vertical portion.

11. The assembly of claim 10, wherein the arc defines a semi-circle.

12. The assembly of claim 10, wherein the hook extension has a length of at least twice the radius.

13. The assembly of claim 11, wherein the arc is in a range of approximately 170 to 190°.

14. The assembly of claim 9, wherein the single piece of bent material further includes,
a partial loop formed along the lateral portion and positioned toward the vertical portion, the partial loop sized to receive a second wire form.

15. The assembly of claim 9, wherein the planar base portion is formed into a shape selected from the group consisting of: a semi-circular shape, a geometric shape, a letter shape, a freeform shape, and an animal shape.

16. A multi-tiered vertical pot hanger assembly for hanging a plurality of pots in a vertically tiered arrangement comprising:
a first wire pot hanger and a second pot hanger for hanging from the first pot hanger;
the first wire pot hanger including,
a wire form comprising a plurality of bends, the wire form including,
a first planar base portion sized to support a first pot,
a first lateral portion extending inwardly from the first planar base portion to a first centered balance point of the first planar base,
a first vertical portion extending upwardly from the first lateral portion, the first vertical portion configured for extending through a first central hole of the first pot,
a first hook portion formed along an upper end of the vertical portion, the hook portion sized to pass through the first central hole of the first pot, and
a first partial loop formed along the first lateral portion and proximal with the first vertical portion; and
the wire second pot hanger mechanically coupled with the first pot hanger along the first partial loop, the second wire pot hanger including,
a second wire form comprising a plurality of bends, the second wire form including,
a second planar base portion sized to support a second pot,
a second lateral portion extending inwardly from the second planar base portion to a second centered balance point of the second planar base,
a second vertical portion extending upwardly from the second lateral portion, the second vertical portion configured for extending through a second central hole of the second pot,
a second hook portion formed along a second upper end of the second vertical portion, the second open wire loop sized to pass through the second central hole of the second pot.

17. The assembly of claim 16, wherein the first and second hook portions each comprise:
a hook extending through an arc having a radius;
a hook extension extending from the hook toward the lateral portion, wherein the hook extension is off-set from the vertical portion by the radius, and
a hook connector extending from the hook extension toward the vertical portion.

18. The assembly of claim 17, wherein the arc defines a semi-circle.

19. The assembly of claim 17, wherein the hook extension has a length at least twice the radius.

20. The assembly of claim 18, wherein the arc is in a range of approximately 170 to 190°.
